(19) United States
(12) Patent Application Publication
(10) Pub. No.: US 2012/0027173 A1
(43) Pub. Date: Feb. 2, 2012

(54) STRUCTURED ELECTRON EMITTER FOR CODED SOURCE IMAGING WITH AN X-RAY TUBE

(75) Inventor: Martin Kimutai Duerr, Aachen (DE)

(73) Assignee: KONINKLIJKE PHILIPS ELECTRONICS N.V., EINDHOVEN (NL)

(21) Appl. No.: 13/260,582

(22) PCT Filed: Mar. 22, 2010
(86) PCT No.: PCT/IB10/51230

§ 371 Date: Sep. 27, 2011

(30) Foreign Application Priority Data
Mar. 27, 2009 (EP) 09156403.9

(51) Int. Cl. G01N 23/04; H01J 35/04; B82Y 20/00; B82Y 99/00

(52) U.S. Cl. 378/62; 378/122; 977/742; 977/950

(57) ABSTRACT

An electron emitter (1) and an X-ray tube (100) comprising such electron emitter (1) are presented. The electron emitter (1) comprises a cathode (3) and an anode (5) wherein the cathode (3) comprises an electron emission pattern (9) of a plurality of local areas (11) spaced apart from each other, each area being adapted for locally emitting electrons via field emission upon application of an electrical field between the cathode (3) and the anode (5). Electron beams (15) emitted from the local areas (11) may generate several X-ray source intensity maxima in a specific geometric pattern. An apparent loss in spatial resolution due to overlapping images on a detector can be corrected by using specific intensity patterns for the X-ray source (100) and by applying dedicated decoding algorithms on the acquired image such as coded source imaging (CSI).

### FIELD OF THE INVENTION

The present invention relates to an electron emitter for an X-ray tube. Furthermore, the invention relates to an X-ray tube comprising such electron emitter and to an X-ray image acquisition device comprising such X-ray tube. Furthermore, the invention relates to a method of acquiring an image of an object e.g. by transmission radiography with X-rays, to a computer program element adapted for controlling such method when executed on a processor and to a computer-readable medium having such computer program element stored thereon.

### BACKGROUND OF THE INVENTION

Conventional X-ray imaging applications based on transmission radiography usually rely on principles of an ideally point-like source of X-rays. However, an ideally point-like source can never be realized and the actual X-ray source will always have a spatial extension which to some degree determines the spatial resolution of the imaging system. Therefore, the imaging application sets constraints on the source dimensions. For a particular size of the X-ray source, and unless the resolution is not compromised by other components in an imaging chain as for example a detection device, the available image quality is ultimately determined by a signal-to-noise ratio. Consequently higher X-ray flux is always desired in imaging applications in order to keep acquisition times as short as possible.

A conventional standard for X-ray generation is an X-ray tube in which X-rays are produced by accelerated electrons impinging onto a solid target material. In good approximation a spatial dimension of the electron beam at the incident on the target determines size of the source of generated X-rays. In the X-ray tube, the area where electrons penetrate the target and X-rays are generated is called the focal spot. In order to achieve a specific spot size, dimensions of the focal spot need to be controlled, for example by focusing the electrons onto the target with electron optics comprising electric and/or magnetic fields. Another method to influence the dimensions of the X-ray source is to use a collimator for the X-rays. Focusing of X-rays is highly wavelength selective and therefore strongly reduces the X-ray flux of an X-ray tube and is therefore in most cases impractical.

However, when focusing an electron beam to a small focal spot on a target, care must be taken not to induce various problems or limiting effects.

First, in X-ray tubes, a careful design of components such as a cathode and an electron optics influencing the optical properties of the electron beam may be required. In particular for a small focal spot with sizes reaching the micrometer range, electron-optical aberrations may present a technical challenge. Furthermore, space-charge effects may influence the size of the focal spot at high current densities of the electron beam. As an alternative to focusing the electron beam in order to generate a small focal spot on the X-ray target, a further method to control the size of the X-ray source may be provided by collimation with a pinhole with a sufficiently small diameter. However, collimation is demanding for small diameters for example in the micrometer range, because the efficient absorption of X-rays by the collimator needs to be insured. This is particularly true for hard X-rays having for example energies of approximately 100 keV which are frequently used for medical imaging applications.

Second, in an X-ray tube, a major fraction of the electron energy is usually converted into heat. This leads to a temperature rise in target material where the highest temperatures appear in the focal spot. As a result, the electron beam current is limited by the need to prevent melting of the target material. An excessive beam current may lead to target overheating which has to be avoided in order to preserve the function of the X-ray source. It has been shown theoretically that the temperature rise in the focal spot is proportional to the power density of the impinging electron beam. Hence, a trade-off between focal spot size and X-ray intensity is encountered for X-ray generation in conventional X-ray tubes. For imaging applications this means a trade-off between resolution and signal-to-noise ratio of an acquired object image.

Target overheating may represent a great challenge in X-ray tube design. For medical imaging, a rotating target is the standard strategy for dealing with the thermal load in the focal spot. However, applications like cardiac computer tomography may strongly benefit from X-ray tubes with even higher X-ray output. For microfocus X-ray tubes with tiny focal spots in the range of micrometres, mechanical tolerances of a rotating anode may become too large for the required spatial stability of the X-ray source. A limited X-ray flux may be responsible for long acquisition times in high resolution X-ray inspection devices.

An alternative to the above described X-ray source with a single X-ray intensity maximum emanating from a single focal spot may be the approach of the so-called coded source imaging (CSI) with X-rays. A basic idea behind CSI is to use a structured source of X-rays with multiple intensity maxima instead of a single one. When used in an X-ray imaging device, such multiple intensity maxima may lead to overlapping images on a detection screen, resulting in an apparent loss of spatial resolution of the imaged object. However, when the exact intensity pattern of the X-ray source is known, a decoding algorithm can be used to correct for the overlapping from the different intensity maxima and a congruent object image may be obtained. The achievable resolution may still be determined by the size of an isolated X-ray intensity maximum and not by the envelope of the X-ray source intensity distribution.

The idea of CSI is inspired by so-called coded aperture imaging (CAI) which has found application in X-ray astronomy and radio nuclide imaging. In brief, CAI is an extension of a pinhole camera for X-rays where instead of a single pinhole a coded aperture mask is used. The coded mask allows to record images with higher signal intensity as opposed to a single pinhole collimator.

This idea can be transferred to coded source imaging. Principles of coded source imaging for X-ray examination are presented in Antonio L. Damato: “Coded source imaging for neutrons and X-rays”, 2006 IEEE Nuclear Science Symposium Conference Record, pages 199-203. In brief, an idea behind coded source imaging is to exchange a single nearly point-like source of X-ray radiation, which may be realized by a pinhole, with another brighter one. One goal may be to improve imaging characteristics by increasing signal-to-noise ratio. This goal may be reached by increasing the transmitting area of the pinhole thus increasing the flux of X-rays used for imaging. However, since the achievable resolution always depends on the geometrical extension of the single X-ray source, such an increase of the source size will lead to a deterioration of the achievable resolution. Another simple idea to increase the signal-to-noise ratio may be to replace the single pinhole with two pinholes. It is straight forward to see that the number of photons actually used in imaging may double. Two images of the object under examination are cast on a detector. If the pinhole distance is chosen so that the two images are not overlapping, a reconstruction involving joining the two images will give better count statistics than a single pinhole would. Instead of two pinholes, a set of a multiplicity of pinholes can be provided to obtain a coded source. For specific geometrical arrangement of the multiple pinholes, the achievable spatial resolution is not influenced by the use of a multiplicity of sources, but is determined by the size of the single pinhole. Therefore, there is an advantage in using a multiplicity of pinholes i.e. a coded source in order to increase the X-ray flux over increasing the size of the single pinhole, since a coded source may increase the signal-to-noise ratio without deterioration of the achievable imaging resolution. The example of the two-pinhole coded source may underline two basic features of CSI: (a) The importance of the pattern in the coded source and (b) the need for subsequent decoding of the detected image. A specific choice of the coded source pattern may be paramount in an optimization of the signal-to-noise ratio of a system. The decoding of the detected image may also depend on the pattern.

### SUMMARY OF THE INVENTION

There may be a need for an electron emitter, an X-ray tube comprising such electron emitter and an X-ray image acquisition device comprising such X-ray tube wherein at least some of the above-mentioned deficiencies described in the context of conventional X-ray tubes may be reduced or overcome. Particularly, there may be a need for an electron emitter, an X-ray tube and an X-ray image acquisition device wherein the X-ray image acquisition device may be advantageously adapted for coded source imaging. Furthermore, there may be a need for a method of acquiring an image of an object, a computer program element for controlling such method when executed on a processor and a computer-readable medium having such computer program element stored thereon, wherein the method allows to overcome at least some of the above-mentioned prior art deficiencies and may be specifically adapted for coded source imaging.

These needs may be met by the subject-matter according to the independent claims. Advantageous embodiments of the present invention are described in the dependent claims.

According to a first aspect of the present invention, an electron emitter for an X-ray tube is presented. The electron emitter comprises a cathode and an anode. Therein, the cathode comprises an electron emission pattern of a plurality of local areas spaced apart from each other, each area being adapted for locally emitting electrons via field emission upon application of an electrical field between the cathode and the anode.

According to a second aspect of the present invention, an X-ray tube is presented, the X-ray tube comprising the electron emitter according to the first aspect of the invention and further comprising a target area adapted for X-ray emission upon impact of accelerated electrons. Therein, the X-ray tube is adapted such that electrons emitted from areas of the electron emission pattern of the cathode of the electron emitter impinge onto the target area in a pattern corresponding to the electron emission pattern.

According to a third aspect of the present invention, an X-ray image acquisition device is presented. The device comprises an X-ray tube according to the above second aspect of the present invention and further comprises an X-ray detector and an image processor. Therein, the X-ray detector is adapted for detecting an intensity distribution of X-rays coming from the X-ray tube. Furthermore, the image processor is adapted for deriving image information based on information of both, the detected intensity distribution and the electron emission pattern.

According to a fourth aspect of the present invention, a method of acquiring an image of an object is presented. The method comprises: emitting electrons from an electron emission pattern of a plurality of local areas spaced apart from each other, each area being adapted for locally emitting electrons via field emission upon application of an electrical field between a cathode and an anode; generating X-rays upon impact of electrons emitted from the electron emission pattern; transmitting the X-rays through the object; detecting the transmitted X-rays with an X-ray detector adapted for detecting an intensity distribution of X-rays; and deriving the image based on information of both, the detected intensity distribution and the electron emission pattern.

According to a fifth aspect of the present invention, a computer program element is presented. The computer program element is adapted for controlling the method according to the fourth aspect of the invention when executed on a processor.

According to a sixth aspect of the present invention, a computer-readable medium is presented. The computer-readable medium has a computer program element according to the fifth aspect of the invention stored thereon.

A gist of the present invention may be seen as being based on the following ideas:

As described above, conventional X-ray tubes having a single focused electron beam impacting an X-ray emitting target may suffer from restrictions such as a limited signal-to-noise ratio and target overheating. The approach proposed herein includes the generation of a spatially structured electron beam using a structured electron emitter having a pattern of electron emission areas. Thereby, a spatial modulation of an electron beam intensity can be achieved. For example, a multiplicity of separate electron beams can be emitted by the electron emitter, wherein each local electron emission area emits one confined electron beam. A spatially modulated overall electron beam comprising a multiplicity of separate sub-beams may be accelerated towards the anode and may create, upon impact onto a target area, a patterned X-ray source having an X-ray intensity distribution corresponding to the intensity pattern of the electron beam. Thus, the created patterned X-ray source may be used for coded source imaging wherein each of the X-ray intensity maxima may serve as a separate X-ray source. The X-rays of the combination of all X-ray sources may then be transmitted through an object to be observed. The transmitted X-ray intensities can be detected by an X-ray detector. The detected X-ray intensity distribution may correspond to overlapping X-ray projections from each of the multiplicity of separate X-ray sources provided by the X-ray tube. From the detected X-ray intensities, an image of the object to be observed can be derived using information of both, the detected intensity distribution as well as the electron emission pattern of the electron emitter. Knowing exactly the pattern of the local electron emission areas in the electron emitter may provide information on the X-ray intensity distribution of the X-ray tube in which electrons coming from the local electron emission areas are projected onto a target area. This information on the patterned X-ray intensity distribution may be used to “decompose” or “deconvolute” the measured transmitted total X-ray intensity distribution, thereby allowing the generation of a high quality X-ray image in which the resolution is mainly set by the size of an isolated intensity maximum and not by the envelope of the overall X-ray source intensity distribution.

In other words, by using a structured source of electrons, multiple intensity maxima of X-rays with a specific pattern can be generated, which contribute to the image signal without compromising image quality. Therefore, the electrons can impinge on a larger region in the target area which may relax the thermal limitations. This may allow an increase of X-ray output thus enabling image acquisition within a shorter time and having a better signal-to-noise ratio.

In the electron emitter according to the first aspect of the invention each of the plurality of local areas is adapted for locally emitting electrons via field emission. Electron emission based on field emission may provide several advantages compared to thermoionic emission of electrons. For example, the emitter can be designed such that field emission can be confined to well-defined areas.

For thermoionic emission, the electron emitting material usually needs to be heated to elevated temperatures of more than 1.000° C. The control of such high temperatures may be difficult because of for example the lateral transport of heat of an electron emitting surface through thermal diffusion and/or radiation. Therefore, in thermoionic electron emitters, the temperature distribution may hardly be maintained in a stable manner.

In contrast hereto, electrons emitted by field emission may be emitted from an emitter's surface which does not have to be heated. Field emitting areas can be structured by approved methods such as lithographic processing such that well-defined local electron emission areas can be defined. As described in more detail further below, carbon nanotubes can be grown on a substrate in particular patterns and arrangements. The size of such local field emitting areas may span a wide range of a few micrometres up to several millimetres. As the electrons emitted by field emission are “cold”, i.e. have a lower kinetic energy, the velocity spread of such field emitted electrons may be lower than that of electrons emitted by thermionic emission at higher temperatures. Due to this reduced velocity spread, the electrons are emitted with a reduced divergence.

In the following, possible features and advantages of embodiments of the various aspects of the present invention will be described.

The electron emitter according to the first aspect of the invention comprises a cathode and an anode. During operation, a voltage can be applied between the cathode and the anode such that a strong electrical field is created there between.

The cathode may comprise a surface directed towards the anode. On this surface, the plurality of local electron emission areas may be provided. As described in detail further below, these areas may be provided with a specific geometry, i.e. for example a specific size of the areas and distance between the areas, with a specific material and/or with a specific surface structure in order to be suitably adapted for field emission of electrons with a desired intensity distribution.

The anode can be adapted such that, preferably, a homogeneous electric field can be created between the cathode and the anode upon applying a voltage. For example, a ring electrode or a mesh electrode may be provided. Both, the anode and the cathode may be provided with an electrically conducting material.

Field emission of electrons from a solid conductor may take place when a very high external electrostatic field is applied. Usually, this high electric field at the surface of the emitter is obtained by applying a microscopic external field in the order of 10 kV/mm and, preferably, enhancing this field locally at sharp needles or edges at the emitter surface to a much higher value. The external electric field may reduce the surface potential barrier to allow electrons to tunnel through this barrier and leave the solid material. The field emission current follows the so-called Fowler-Nordheim equation and depends on the magnitude of the electric field, the work function of the emitter material and the local field enhancement factor due to the geometry of the emitter surface. Thus, the field emission current may strongly depend on the work function of the material and on the applied, possibly locally enhanced electric field.

As the electron emission areas are “cold” emitters, the anode or grid electrode may be placed in close proximity to the cathode to allow for very fast, low voltage switching. Furthermore, since the field emission current depends directly on the extracting electric field, the anode can also be used to modulate the electron beam current. For example, the field emission can be switched by switching the voltage to a lower voltage such that the field emission is reduced or suppressed. This may be a very interesting option for application in medical X-ray examination e.g. for fast dose modulation. Since the electrons are “cold”, they are emitted with a low divergence. As a result, the electron emission pattern may be mapped directly onto the target, creating a corresponding X-ray source pattern.

According to an embodiment, a width of a local area on the cathode of the electron emitter is smaller than a distance to a closest adjacent local area. In other words, the lateral dimensions of each of the local areas may be smaller than the lateral dimensions of the spaces between adjacent local areas. For example, the lateral dimensions of the local areas may be in a range from a few micrometres to a few millimetres, for example between 1 μm and 20 mm, preferably between 3 μam and 10 mm. The distance between adjacent local areas is at least larger than the lateral dimension of the local areas, preferably at least double the dimension of the local areas and further preferably at least 5 times the dimensions of the local area. For example, the distance between adjacent local areas may be between 5 μm and 10 mm, preferably between 10 μm and 2 mm. Each of the local areas may have an arbitrary contour, for example circular or square. Individual local areas may differ in their lateral dimension and shape. When local areas have varying lateral dimensions, the minimal lateral dimension of the plurality of local areas may be smaller than the lateral dimensions of the spaces between adjacent local areas. The plurality of local areas can be arranged in any arbitrary pattern, for example in a square matrix. The geometry and arrangement of the local areas may be adapted such that the resulting electron beams emitted from the local areas may provide for, upon impact onto an X-ray target area, an X-ray intensity distribution which is then suitable for coded source imaging.

According to an embodiment, the local areas on the cathode of the electron emitter are provided with a microscopically rough surface. This rough surface may be adapted for maximizing the electron emission current generated by field emission from the local areas. As already indicated above, field emission may be a result of quantum mechanical tunnelling of electrons through the surface potential barrier of the bulk into free space. The number of field emitted electrons is strongly dependent on the local electrical field E [V/m] at the corresponding surface. The field emission current can be increased by using a rough surface including sharp conducting pins, since at small structures, a strong enhancement of the local field strength may occur. In a diode-type arrangement, the electric field is generated by a voltage applied between the cathode and an opposing anode. The macroscopic field can be approximately quantified by the voltage U and the distance d and amounts to U/d. Locally, the strength of the electric field near the emitter may vary from U/d, since the macroscopic field may induce a charge distribution. The field enhancement may depend on the geometrical form of the field emitter and the geometrical arrangement of adjacent field emitters. Quantitatively, the field enhancement maybe described by a field enhancement factor γ, such that the electrical field is E=γ(U/d). Electron emitters based on field emission may benefit from such field enhancement as it reduces the external voltage needed to create a local field which provides sufficient field emission. Preferably, the field emitters have a conical form with a very narrow tip as such a geometrical shape leads to strong field enhancement.

The geometrical shape of field emitters may be designed by structuring materials in a manner which favours field enhancement. Preferably the structure size is in a range of nanometers ranging to few micrometers which may be generated by nanofabrication techniques, e.g. electron beam lithography, focused ion beam machining or molecular self assembly techniques. Accordingly, an arrangement of multiple field emitters in an array may be realized with such manufacturing process. Alternatively, an irregular arrangement of field emitting structures may be realized such that the field emitting surface effectively posses a roughness, where field enhancement occurs in elevations of the rough surface. The detailed surface morphology leading to optimal field emission current may depend on the chemical composition and the thus related material properties like the electrical work function or mechanical strength of the field emitter.

The surface roughness may be characterized by a scanning probe technique, e.g. an atomic force microscope, or by high resolution surface imaging techniques such as a scanning electron microscope. The roughness may be determined by scanning the surface in steps of 5 nm over surface area of 5 μm by 5 μm. The surface morphology manifests itself as peaks and valleys from the surface profile obtained in the scanning procedure. For field emission a large ratio of the width and height of the protuberances is beneficial. Preferably the average ratio of peak height and peak width amounts at least a factor of five, preferably between 100 and 1000.

According to an embodiment of the invention, the local areas on the cathode of the electron emitter comprise a surface layer made of carbon nanotubes (CNT). Carbon nanotubes may be described as sheets of graphene that are rolled up and form thin and long tubes. While the length can attain several micrometres and even millimetres, the width of the tubes may be only a few nanometres. Single-walled nanotubes (SWNT) consist of a single graphene cylinder. Multi-walled nanotubes (MWNT) consist of several graphene sheets rolled up in a nested, onion-like structure. MWNTs usually are electrical conductors, while SWNTs are either semi-conducting or metallically conducting, depending on the way the graphene sheet is rolled up.

MWNTs may have several prominent characteristics. They may be good electrical conductors and their high aspect ratio and low work function of about 5 eV making them good candidates for field emission. As their walls are made of a very strong graphite structure, they may have also a high mechanical strength and furthermore they are chemically rather inert and sputter-resistant. These characteristics may be advantageous to achieve the desired lifetime for electron emitters in X-ray tubes. The high mechanical strength may allow to produce a field emitter with a large aspect ratio, i.e. a large ratio of length and diameter. This may lead to an advantageous field enhancement factor. For the surface layer of CNT emitters different surface morphologies may exist. Singly isolated tubes may be arranged on the surface, where all tubes are aligned with respect to each other and the distance between individual CNT can be much larger than their length. Alternatively, CNTs may be densely arranged adjacent next to each other either in an array or with random orientation of the tubes with respect to each other. Depending on the surface morphology, selected CNT will protrude above the surface thus experiencing a stronger effect of field enhancement. These CNT emitters may predominantly contribute to the electron emission current.

The contributing CNT emitters preferably have a lateral distance to an adjacent neighbour in order to avoid shielding which would reduce the field enhancement. However, a sparse density reduces the number of contributing CNT emitters per unit area. Therefore there is an optimal distance between elevated CNT emitters which maximizes the field emission current. As in the case of CNT emitters the preferable distance between field emitting pins is preferably two times as large as their height above the surface areas which do not or only minimally contribute to field emission.

Individual CNTs are reported to be able to carry stable emission currents of up to 1 μA. Since medical X-ray tubes may require electron beam currents in the range of roughly 100 mA to more than 1 A for the high power tubes, well-emitting CNT arrays that cover an area of 1 cm² may be required to manufacture a cold electron emitter for an X-ray tube.

One method to dispose CNTs and control the surface morphology is by creating defined areas populated with field emitters on a planar substrate, e.g. by lithographic processing of the substrate, as described for example by Z. Chen: “Fabrication and characterization of carbon nano arrays using sandwich catalyst stacks”, Carbon 44, 2006, pages 225-230.

In order to increase the surface roughness of a deposited CNT layer, the layer, after deposition, may be treated by a microwave plasma comprising for example hydrogen (H₂), nitrogen (N₂) or oxygen (O₂). Thereby, e.g. unwanted amorphous carbon components may be removed from the CNT-covered areas thereby exposing a very rough surface which may be created by the underlying vertically adjacent CNTs.

According to an embodiment of the present invention, the local areas of the electron emission pattern on the cathode of the electron emitter are arranged two-dimensionally in a plane. For example, the local areas can be arranged in a matrix-like pattern with linear columns and lines of local areas arranged adjacent to each other and being spaced apart from each other by a sufficient distance. The arrangement and dimensions of local areas in the electron emission pattern in two dimensions may be adapted such that, as a result of the emitted electron beams, a modulated X-ray intensity distribution is generated upon impact onto a target area which intensity distribution is suitable for subsequent coded source imaging.

According to an embodiment of the present invention, the electron emission pattern on the cathode of the electron emitter comprises uniform redundant arrays. Such uniform redundant arrays (URA) have originally been developed for coded aperture imaging (CAI) and have been described for example by E. E. Fenimore and T. M. Cannon in Applied Optics, 1. February 1978, vol. 17, no. 3, pages 337-347. URAs have autocorrelation functions with perfectly flat side lobes. The URA combines the high-transmission characteristics of a random array with a flat side lobe advantage of a non-redundant pinhole array. In transmission radiography with x-rays using a source pattern according to a URA, the autocorrelation function represents the system point spread function. This gives X-ray imaging with URA the capability to image with a increased signal-to-noise ratio compared to single source imaging.

The X-ray tube according to the above-described second aspect of the present invention comprises, additionally to the electron emitter as described previously herein, a target area adapted for X-ray emission upon impact of accelerated electrons. This target area may be part of the anode of the electron emitter such that electrons emitted from the local areas on the cathode and accelerated towards the anode by the electric field applied there between and then impinging onto the target area of the anode generate X-rays which may then be emitted in a direction towards an object to be examined. Alternatively, the target area may be portion of a separate target being arranged within the path of the electron beam emitted from the cathode in a direction towards the anode. The material of the target area may have a large atomic number and/or a large effective cross-section with the impinging electron beam such that X-rays are effectively generated upon impact of accelerated electrons. For example, the target area may be made from a high-temperature resistant heavy material such as Tungsten or Molybdenum.

The X-ray tube according to an embodiment of the present invention is adapted such that electrons emitted from the local areas of the electron emission pattern of the cathode impinge onto the target area in a pattern corresponding to the electron emission pattern. In other words, electrons emitted at the surface of the cathode within the electron emission pattern may be accelerated towards the target area wherein the overall electron intensity distribution is substantially preserved upon impact of the electrons on the target area. Thereby, the X-rays generated at the target areas may comprise an X-ray intensity distribution which generally corresponds to the electron intensity distribution emitted at the electron emission pattern. Thus, as the electron emission pattern can be easily structured for example by lithographic processing, a desired X-ray intensity distribution can be generated using the above-described electron emitter which X-ray intensity distribution may be suitable for subsequent coded source imaging. When electron trajectories are distorted, the field emitting areas may be arranged such that the electron intensity distribution upon incidence on the target area creates the desired X-ray intensity distribution.

According to an embodiment of the present invention the target area is adapted as transmission target such that upon impact of electrons from one side of the target area X-rays are emitted at an opposite side of the target area. For example, the target area can be provided as a thin sheet or foil of X-ray emitting material such as Tungsten or Molybdenum. The sheet or foil may have a thickness which is as small as enabling Bremsstrahlung generated upon impact of accelerated electrons to be transmitted to an opposite surface and to be emitted therefrom towards an object of interest.

According to an embodiment of the present invention, the target area is adapted as a slanted target such that upon impact of electrons from one side of the target area X-rays are emitted at the same side of the target area in a direction having an angle to the direction of the impacting electrons. Such slanted target may be made with a same or a similar material as the transmission target described above but may have a larger thickness such that Bremsstrahlung generated upon impact of accelerated electrons is not transmitted to an opposite surface but may exit the target at the surface of impact of the electrons. By arranging the target area at a slanted angle with respect to the beam of incoming electrons, the generated X-rays may be emitted not in a direction directly opposite to the direction of the incoming electrons but in a direction having an angle of e.g. between 10° and 170°, preferably between 80° and 100°, to the direction of the incoming electrons. The slanted target may be a fixedly installed target or a rotating target. An advantage of a slanted anode may be the reduction of apparent source side viewed from the direction of intended x-ray emission.

According to an embodiment of the present invention, the X-ray tube further comprises a voltage source adapted for applying a voltage between the cathode and the anode of the electron emitter such that an electrical field of at least 1 kV/mm, preferably at least 4 kV/mm, is established. It has been found that applying such strong electric field between the cathode having the electron emission pattern thereon and the anode may enable or support field emission of electrons from the electron emission pattern. The voltage source may be a part of the X-ray tube, integral or as a separate device, or, alternatively, the voltage source may be a part of the electron emitter itself.

The X-ray image acquisition device according to the third aspect of the present invention comprises the above-described X-ray tube according to the second aspect of the invention and furthermore comprises an X-ray detector and an image processor.

The X-ray detector is adapted for detecting an intensity distribution of X-rays coming from the X-ray tube. For example, the X-ray detector may be a two-dimensional detector array adapted for detecting a two-dimensional intensity distribution of X-rays simultaneously. Alternatively, the X-ray detector may be a one-dimensional line detector or, in an extreme case, even a single pixel detector which may scan the one-dimensional or two-dimensional intensity distribution of X-rays coming from the X-ray tube.

The image processor is adapted for deriving image information based on information of both, the detected X-ray intensity distribution and the electron emission pattern of the cathode of the electron emitter. In other words, the image processor, on the one hand, receives information about the detected X-ray intensity distribution for example directly from the X-ray detector. On the other hand, the image processor has information about the pattern of local electron emission areas on the cathode and, thereby, at least indirectly, having information about the local intensity distribution of the X-rays emitted by the X-ray tube. Having this information, the image processor may derive an image of the object to be examined and through which the X-rays from the X-ray tube have been transmitted before being detected by the X-ray detector, wherein the image processor may use the information about the electron emission pattern in order to generate a high quality X-ray image of the object by reconstruction/deconvolution of the X-ray intensity distribution detected by the X-ray detector. The X-ray intensity distribution of the X-rays emitted from the X-ray tube may be determined by placing objects with well defined transmission behaviour over its geometrical area. One example is a pinhole with small diameter which may cast a magnified projection of the X-ray intensity distribution of the source onto the X-ray detector.

According to an embodiment of the invention, the image processor is adapted for coded source imaging. Details and principle of such coded source imaging have already been described further above.

Features and principles of the above-described electron emitter, X-ray tube and X-ray acquisition device may also be transferred to the method of acquiring an image of an object according to the fourth aspect of the present invention, the computer program element according to the fifth aspect of the present invention and the computer-readable medium according to the sixth aspect of the present invention.

Expressed in other words, features of the invention and its embodiments may be summarized as follows: While most conventional X-ray imaging applications rely on X-ray tubes which generate a single—ideally point-like—source of X-rays, it is proposed herein to provide a structured electron emitter for X-ray tubes such that the electron beam generates several X-ray source intensity maxima in a specific geometrical pattern instead of only a single intensity maximum. Therefore, electron currents are emitted from specific local areas on a cathode by field emission. An apparent loss of spatial resolution due to overlapping images on the detector can be corrected by using specific intensity patterns for the X-ray source and by applying dedicated decoding algorithms on the acquired image. Using such a so-called coded source imaging scheme provides a way of increasing the X-ray output without sacrificing spatial resolution.

It has to be noted that features and advantages of the present invention have been described with reference to different embodiments of the invention, particularly, features and advantages have been presented with respect to different apparatus-type aspects and method-type aspects of the invention. However, a person skilled in the art will gather from the above and the following description that, unless other notified, in addition to any combination of features belonging to one embodiment also any combinations between features relating to different embodiments are considered to be disclosed within this application.

### BRIEF DESCRIPTION OF THE DRAWINGS

Features and advantages of the present invention will be further described with respect to specific embodiments as shown in the accompanying figures but to which the invention shall not be limited.

FIG. 1 shows basic principles of a method of acquiring an image of an object according to an embodiment of the present invention.

FIG. 2 shows a side view of an electron emitter according to an embodiment of the present invention.

FIG. 3 shows a side view of an alternative electron emitter according to another embodiment of the present invention.

FIG. 4 shows a perspective view of an electron emitter with a target area adapted as a transmission target according to an embodiment of the present invention.

FIG. 5 shows a side view of an X-ray image acquisition device with an electron emission similar to the one shown in FIG. 4 according to an embodiment of the present invention.

FIG. 6 shows a perspective view of an electron emitter with a target area adapted as a slanted target according to an embodiment of the present invention.

FIG. 7 shows a side view of an X-ray image acquisition device with an electron emitter similar to the one shown in FIG. 6 according to an embodiment of the present invention.

FIG. 8 shows a top view onto a surface of the cathode of an electron emitter according to an embodiment of the present invention.

FIG. 9 shows an example of an electron emission pattern comprising a uniform redundant array for a cathode of an electron emitter according to an embodiment of the present invention.

FIG. 10 shows an intensity distribution of electrons emitted by the electron emitter shown in FIG. 8 along the line A-A and a corresponding X-ray intensity distribution.

FIG. 11 shows a schematic representation of an X-ray image acquisition device according to an embodiment of the present invention.

All drawings in the figures are only schematically and not to scale. Similar elements in the figures are referred to with similar reference signs.

### DETAILED DESCRIPTION OF EMBODIMENTS

Principles of coded source imaging using embodiments of the present invention will be described with reference to FIG. 1. An X-ray tube 100 is adapted not to emit only a single X-ray beam but a multiplicity of spaced apart X-ray beams 102. The X-ray beams 102 are directed towards an object 104 and transmit the object 104. The transmitted X-rays are then projected onto an X-ray detector 106. On a detection surface of the detector 106, a multiplicity of at least partly overlapping projections of the object 104 by the multiple X-rays 102 is obtained. The detector 106 then transmits the detected image to an image processor 108. This image processor 108 then derives image information of the object 104 by deconvoluting the detected image using previously provided information about the precise arrangement and dimensions of the multiple X-rays 102 emanating from the X-ray tube 100. Thereby, a final image 110 of the object 104 may be obtained wherein the final image has a high resolution which is mainly limited by the quality of one single of the multiplicity of X-rays 102 but not on the envelope of the X-ray distribution provided by all of the X-ray beams 102.

FIG. 2 shows an embodiment of an electron emitter 1. The electron emitter 1 comprises a cathode 3 and an anode 5. The cathode 3 comprises a substrate 7 which on one surface thereof comprises an electron emission pattern 9 including spatially separated local areas 11. The cathode 3 and the anode 5 are connected to a voltage source 13. The local areas 11 are adapted such that upon application of a voltage to the anode 5 and the cathode 3, electrons are emitted from the local areas via field emission. For this purpose, the local areas may be made of a specific material having a small work function so that electrons may relatively easily exit from a surface of the material of the local areas 11. Alternatively or additionally, the local areas 11 may be provided with a rough surface such that at edges or needles of the surface of the local area, the electric field between the anode 5 and the cathode 3 is locally enhanced. For example, the local areas may be covered by a layer of carbon nanotubes which are preferably arranged vertically adjacent to each other so as to form a very rough surface in a direction towards the anode 5. Regions in between the local areas 11 and separating these local areas 11 spatially are adapted such as to emit no or at least only a few electrons via field emission. Accordingly, these intermittent regions may have a different material or a different surface structure such as for example an even surface.

Electrons emitted from the local areas 11 via field emission are then accelerated towards the anode 5 forming electron beams 15. These electron beams 15 may be transmitted through the mesh-like anode 5 and may travel further towards a target of an X-ray tube (not shown in FIG. 2). There, the impacting electron beams 15 may generate respective spaced apart X-ray beams.

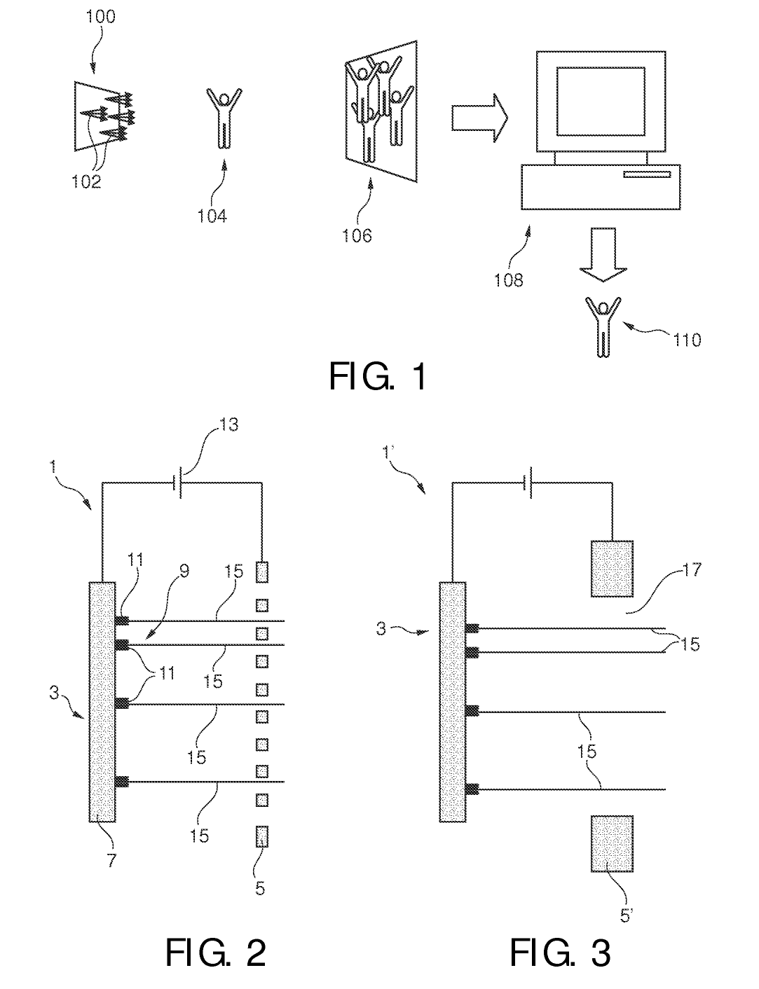

FIG. 3 shows an alternative embodiment of an electron emitter 1′. Therein, the anode 5′ is provided as a ring anode 5′. Electron beams 15 may be transmitted through an inner opening 17 of the ring-anode 5′.

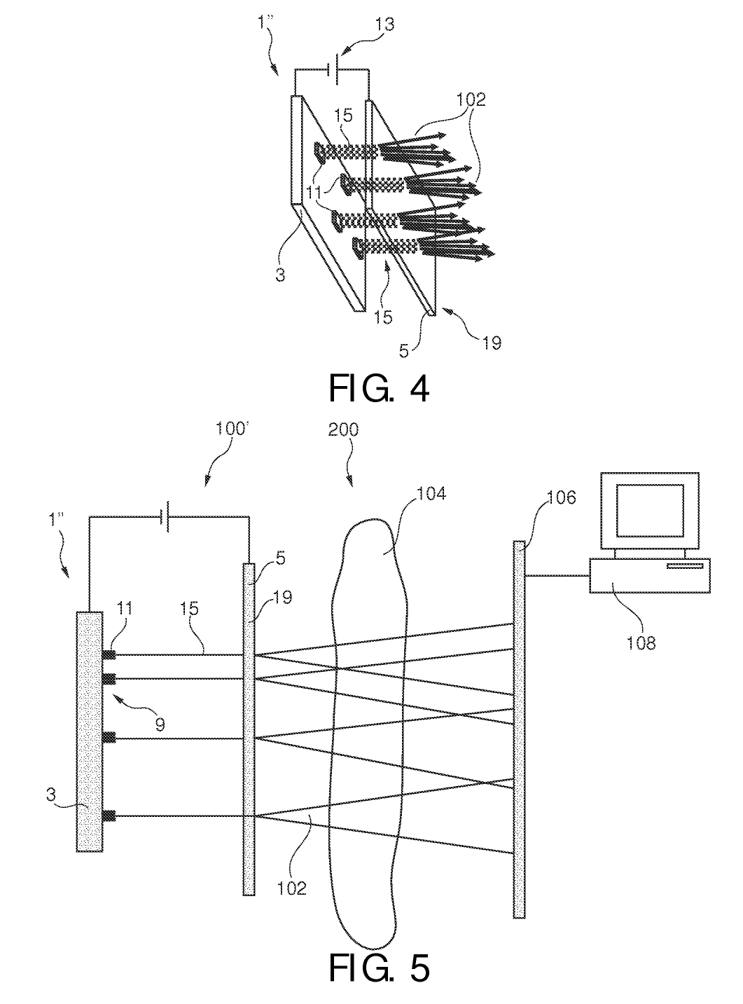

FIG. 4 shows an alternative embodiment of an electron emitter 1″. Therein, the anode 5 also serves as an X-ray target 19. Electron beams 15 emitted from local areas 11 on the cathode 3 are accelerated towards the anode 5 by a voltage applied between the anode 5 and the cathode 3 using the voltage source 13. In this embodiment, the anode 5 is made of a thin foil of Tungsten. Upon impact of the electron beams 15 on the foil of the anode 5, the electrons are decelerated within the foil thereby generating Bremsstrahlung which is transmitted through the foil and emitted as X-ray beams 102 on an opposite side of the anode. Accordingly, the anode 5 serves also as an X-ray target 19.

FIG. 5 schematically shows an X-ray image acquisition device 200 according to an embodiment of the present invention comprising an electron emitter 1″ similar to the one shown in FIG. 4. X-ray beams 102 generated at the anode/target 5/19 of an X-ray tube 100′ are emitted towards an object 104 to be observed. The X-rays 102 transmitted through the object 104 are then projected onto an X-ray detector 106. The detector 106 detects an overall image comprising overlapping sub-images of the separate X-rays 102. The overall image is then transmitted to an image processor 108 where it is deconvoluted in order to generate the final image 110. For the purpose of this decon-volution, it may be important to know the X-ray intensity distribution emitted at the target 19 or, as this X-ray intensity distribution depends on the arrangement of the local areas 11 in the electron emitter 1″, to have precise information about the arrangement and dimensions of the electron emission pattern 9 comprising the local areas 11.

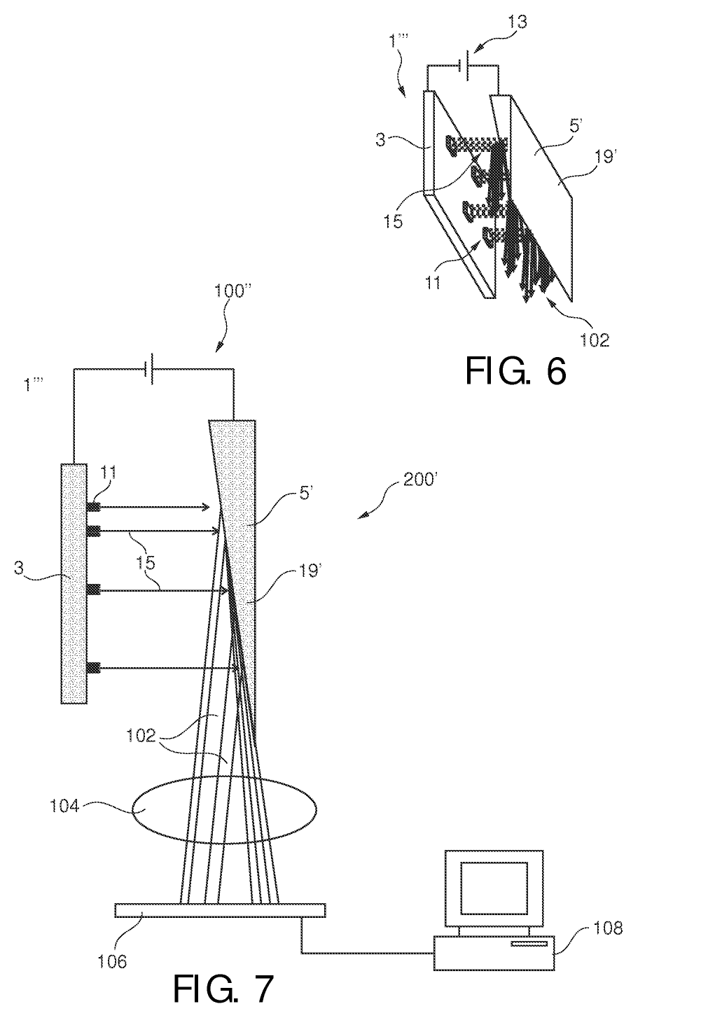

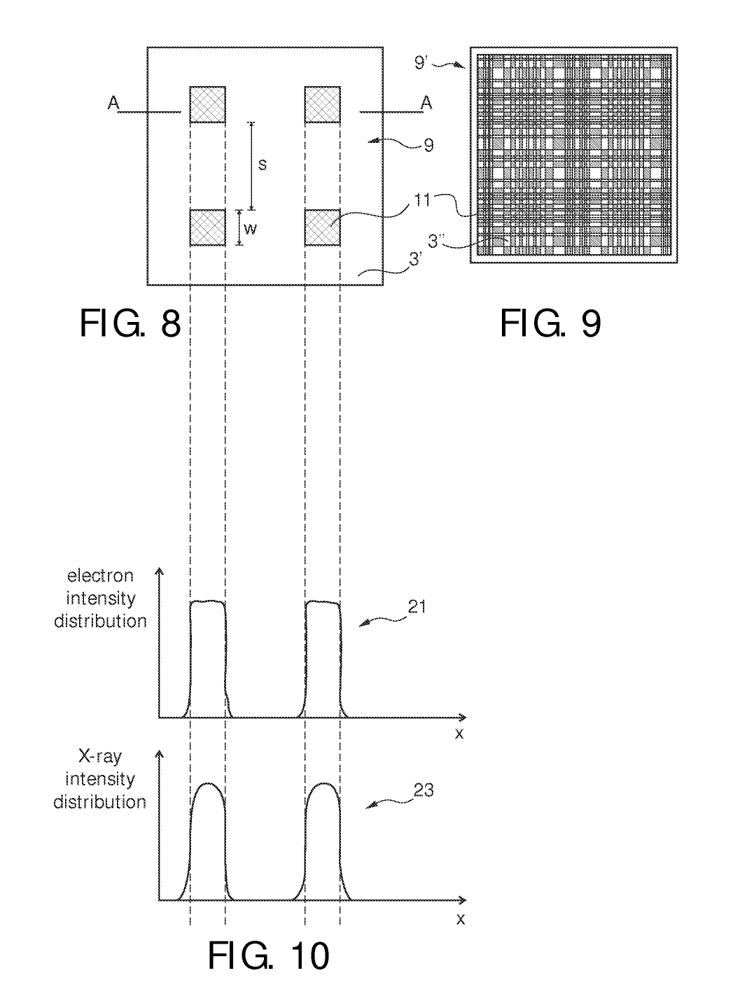

FIGS. 6 and 7 show alternative embodiments of an electron emitter 1′″ and of an X-ray image acquisition device 200′. Therein, the anode 5′ is provided as a solid wedge thereby creating a slanted target 19′. Electron beams 15 coming from the local areas 11 impact onto this slanted target 19′ from one side of the target 19′ and Bremsstrahlung is created. This Bremsstrahlung is emitted as X-rays at the same side of the slanted target 19′ but an angle of approximately 90° with respect to the direction of the electron beams 15. The X-ray beams 102 are then transmitted through an object 104 and detected on an X-ray detector 106 which finally transmits the detection result to an image processor 108.

FIGS. 8 and 9 show schematically top views onto the surface of a cathode 3 of an electron emitter 1 according to an embodiment of the present invention. In FIG. 8, the electron emission pattern 9 is a simple matrix of singular local areas 11 arranged in lines and rows. Therein, the width w of a local area 11 is significantly smaller, for example less than a half, than the distance s between adjacent local areas 11. Of course, the local areas 11 do not have to be rectangular but can have any suitable shape. For the deconvolution of the final image within the image processor 108 it may be important to have precise information about the entire geometry of the electron emission pattern 9, particularly about the shape of the local areas 11, about their lateral dimensions such as the width w and about the distance s between respective adjacent local areas 11. Furthermore, information should be available as to how the geometry of the electron emission pattern 9 is projected via the field-emitted electron beams 15 onto a target 19 in order to have information about the lateral X-ray intensity distribution generated at such target 19.

FIG. 9 shows an alternative example of an electron emission pattern 9′ realized as uniform redundant arrays.

FIG. 10 shows, in its upper graph, an intensity distribution 21 of electrons emitted by the electron emission pattern 9 shown in FIG. 8 along the line A-A in FIG. 8. It can be seen that an electron intensity is maximum in the regions of the local areas 11 whereas in the intermittent spacing regions, an electron intensity is almost zero. Accordingly, the distribution of electron beams along the lateral surface of the electron emitter 1 strongly corresponds to the electron emission pattern 9. In the lower graph of FIG. 10, an intensity distribution 23 of X-rays generated by electrons emitted by the electron emitter 1 impacting onto a target 19 is shown along the line A-A of FIG. 8. It can be seen that the X-ray intensity distribution 23 still has a good correlation to the geometry of the electron emission pattern 9.

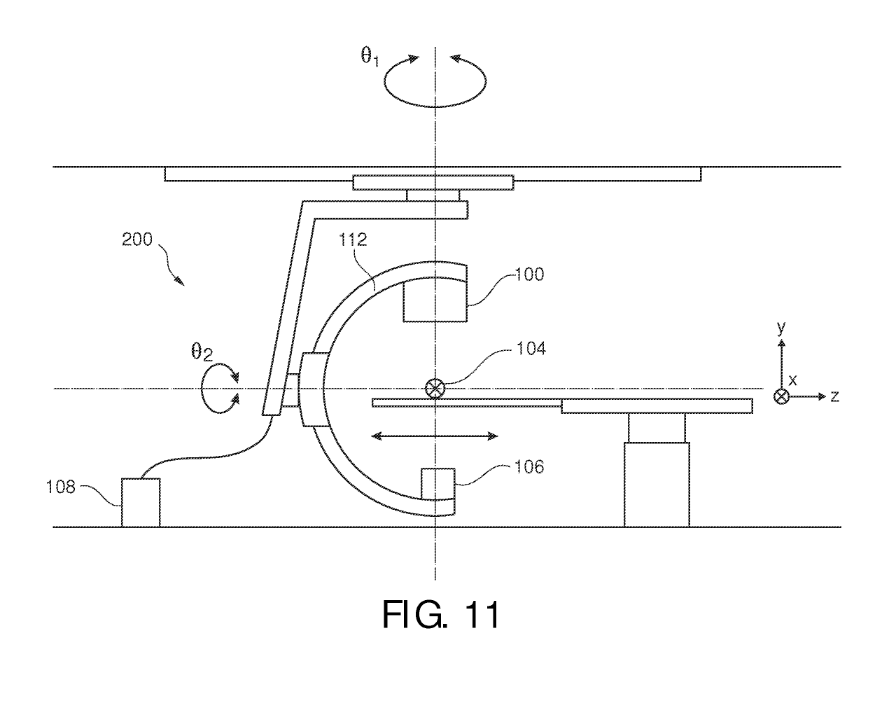

FIG. 11 shows a C-arm X-ray system representing an example of an X-ray image acquisition device 200. An X-ray source 100 and a detector 106 are arranged at a C-arm 112 which may be translated and pivoted with respect to an object 104. Data of the detector may be transferred to an image processor 108.

Finally, it should be noted that the terms “comprising”, “including”, etc. do not exclude other elements or steps and the terms “a” or “an” do not exclude a plurality of elements. Also, elements described in association with different embodiments may be combined. It should also be noted that reference signs in the claims should not be construed as limiting the scope of the claims.

### LIST OF REFERENCE SIGNS

1 Electron emitter
3 Cathode
5 Anode
7 Substrate
9 Electron emission pattern
11 Local area
13 Voltage source
15 Electron beam
17 Anode opening
19 X-ray target
21 Electron intensity distribution
23 X-ray intensity distribution
100 X-ray tube
102 X-ray beam
104 Object
106 X-ray detector
108 Image processor
110 Final image
112 C-arm
200 X-ray image acquisition device

1. An electron emitter (1) for an X-ray tube (100), the emitter comprising:
a cathode (3); and
an anode (5);
wherein the cathode (3) comprises an electron emission pattern (9) of a plurality of local areas (11) spaced apart from each other, each area being adapted for locally emitting electrons via field emission upon application of an electrical field between the cathode (3) and the anode (5).

2. The electron emitter of claim 1, wherein a width (w) of a local area (11) is smaller than a distance to a closest adjacent local area (11).

3. The electron emitter of claim 1, wherein the local areas (11) are provided with a microscopically rough surface.

4. The electron emitter of any of claim 1, wherein the local areas (11) comprise a surface layer made with carbon nanotubes.

5. The electron emitter of any of claim 1, wherein the local areas (11) of the electron emission pattern (9) are arranged two-dimensionally in a plane.

6. The electron emitter of claim 1, wherein the electron emission pattern (9) comprises uniform redundant arrays.

7. An X-ray tube (100), comprising
an electron emitter (1) according to claim 1; and
a target area (19) adapted for X-ray emission upon impact of accelerated electrons;
wherein the X-ray tube (100) is adapted such that electrons emitted from local areas (11) of the electron emission pattern (9) of the cathode (3) impinge onto the target area (19) in a pattern corresponding to the electron emission pattern (9).

8. The X-ray tube (100) of claim 7, wherein the target area (19) is adapted as transmission target (19′) such that upon impact of electrons from one side of the target area X-rays are emitted at an opposite side of the target area.

9. The X-ray tube (100) of claim 7, wherein the target area (19) is adapted as a slanted target (19″) such that upon impact of electrons from one side of the target area X-rays are emitted at the same side of the target area in a direction having an angle to the direction of the impacting electrons.

10. The X-ray tube (100) of claim 7, further comprising:
a voltage source (13) adapted for applying a voltage between the cathode (3) and the anode (5) of the electron emitter (1) such that an electrical field of at least 1 kV/mm is established.

11. An X-ray image acquisition device (200), comprising:
an X-ray tube (100) according to claim 7;
an X-ray detector (106); and
an image processor (108);
wherein the X-ray detector (106) is adapted for detecting an intensity distribution (21) of X-rays coming from the X-ray tube (100);
wherein the image processor (106) is adapted for deriving image information based on information of both, the detected intensity distribution (21) and the electron emission pattern (9).

12. The X-ray image acquisition device (200) of claim 11, wherein the image processor (106) is adapted for coded source imaging.

13. A method of acquiring an image (110) of an object (104), the method comprising:
emitting electrons from an electron emission pattern (9) of a plurality of local areas (11) spaced apart from each other, each area being adapted for locally emitting electrons via field emission upon application of an electrical field between a cathode (3) and an anode (5);
generating X-rays (102) upon impact of electrons emitted from the electron emission pattern (9);
transmitting the X-rays through the object (104);
detecting the transmitted X-rays with an X-ray detector (106) adapted for detecting an intensity distribution (21) of X-rays; and
deriving the image based on information of both, the detected intensity distribution (21) and the electron emission pattern (9).

14. A computer program element adapted for, when executed on a processor, controlling the method according to claim 13.

15. A computer readable medium having the computer program element of claim 14 stored thereon.
